(19) United States
(12) Patent Application Publication
(10) Pub. No.: US 2002/0087406 A1
(43) Pub. Date: Jul. 4, 2002

(54) Value data management method, value data management system, and miles management method

(75) Inventors: Kunio Hashimoto, Tokyo (JP); Etsuko Ikeda, Tokyo (JP); Kenichi Agarihama, Tokyo (JP); Hideo Tanzawa, Tokyo (JP); Katsuyoshi Yamanouchi, Tokyo (JP); Toshiyuki Jingu, Tokyo (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Japan Airlines Co., Ltd. and Dentsu Inc.

(21) Appl. No.: 09/949,183

(22) Filed: Sep. 7, 2001

(30) Foreign Application Priority Data
Sep. 8, 2000 (JP) 2000-273232

(51) Int. Cl. G06F 17/60

(52) U.S. Cl. 705/14

(57) ABSTRACT

There is provided a value data management method for managing a first value data acquired by each of users and having value exchangeable for specific merchandise, comprising: reading second value data from a first information storage medium and user identification data from a second information storage medium; and updating the first value data acquired by the user corresponding to the user identification data read from the second information storage medium, based on the second value data read from the first information storage medium.

### BACKGROUND OF THE INVENTION

1. Field of the Invention

The present invention pertains to a value data management method, a value data management system, and a miles management method for managing value data acquired by each of users and having value exchangeable for specific merchandise.

2. Description of the Related Art

Conventionally, airlines companies offer mileage service (hereinafter referred to as “miles service”). Miles service refers generally to a service in which miles are issued and accumulated per user in accordance with travel distance and destination each time the user purchases an airline ticket as a registered miles service member, and when a user's acquired member miles (hereinafter referred to as “acquired member miles”, but also known as “award miles”) have reached a certain miles, the acquired member miles are exchanged for merchandise such as a free airline ticket (i.e., this includes the case when an airline ticket becomes purchasable for less money than its price).

The applicant has conceived of the following new service which uses the miles service described above.

First of all, a convenience card is distributed to the user. As an example, inside an airplane on a departure flight the convenience card may be distributed free of charge together with literature describing participating stores where the convenience card can be used at the destination (such as Hawaii). Next, each time the user makes a transaction (i.e., each time the user shops, eats a meal, etc.) at a participating store at the destination, a terminal disposed in the participating store is used to record miles having a value reflective of the monetary amount of the transaction (hereinafter referred to as miles issued by the participating store) onto the convenience card held (or carried) by the user. Then, the user's acquired member miles are updated (or added, for example) based on the miles issued by the participating store and recorded on the convenience card.

According to this new service, it becomes possible to update acquired member miles based on the miles issued by the participating store and recorded on the convenience card. Therefore, the user can more quickly achieve miles which are exchangeable for merchandise.

In order to provide a new service such as this one a method and system for updating the acquired member miles is necessary.

### SUMMARY OF THE INVENTION

An object of the present invention is to provide a method and system for updating the acquired member miles.

A value data management method for managing a first value data acquired by each of users and having value exchangeable for specific merchandise, comprises: reading second value data from a first information storage medium and user identification data from a second information storage medium; and updating the first value data acquired by the user corresponding to the user identification data read from the second information storage medium, based on the second value data read from the first information storage medium.

The first value data is, for example, a number of miles (referred to hereinafter as “acquired member miles”) which are acquired by a user who has joined and is registered as a member of a miles service provided by an airline company (explained below). The second value data is, for example, miles issued by a participating store (referred to hereinafter as “miles issued by the participating store”). The first information storage medium is, for example, a convenience card-type storage medium comprised of a magnetic card, which stores the miles issued by the participating store as magnetic data. The second information storage medium is, for example, a member card comprised of a magnetic card, which stores member identification data as magnetic data.

According to the present invention, it becomes easy to update (by adding, for example) the miles acquired by the user (i.e., the first value data) corresponding to the member identification data which has been read from the member card.

Further, according to another embodiment of the present invention, a value data management method for managing a first value data acquired by each of users and having value exchangeable for specific merchandise, comprises: recording a second value data having a value reflective of the monetary amount of a transaction with a participating store in a specific area in a first information storage medium for each occurrence of the transaction; reading the second value data from the first information storage medium and user identification data from a second information storage medium; and updating the first value data acquired by the user corresponding to the user identification data read from the second information storage medium.

In yet another aspect of the invention, a value data management system for managing a first value data acquired by each of users and having value exchangeable for specific merchandise, comprises: an information acquisition means reading second value data from a first information storage medium and user identification data from a second information storage medium; a calculation means calculating third value data based on the second value data read by the information acquisition means; and an updating means updating the first value data acquired by the user corresponding to the user identification data read by the information acquisition means, based on the third data calculated by the calculation means.

According to the present invention, it becomes easy to update (by adding, for example) the miles acquired by the user (i.e., the first value data) corresponding to the member identification data which has been read from the member card.

It is possible to use a card-type storage medium for each of the first and the second information storage medium. A card reader can be used as the information acquisition means described above. Also, magnetic cards can be used for these cards.

Preferably, the value data management system comprises a printing means for printing an indication on the first card stating that the reading of the second value data recorded on the first card is completed. Also, it is preferable that the value data management system comprises a printing means for printing the second value data onto the first card.

Further, a value data management system according to another embodiment of the present invention comprises: an information acquisition means reading second value data from a first information storage medium and user identification data from a second information storage medium; a calculation means calculating third value data based on the second value data read by the information acquisition means; and an updating means updating the first value data acquired by the user corresponding to the user identification data read by the information acquisition means, based on the third data calculated by the calculation means.

According to the present invention, it becomes possible to calculate a third value data (i.e., converted miles) and update (such as by adding, for example) the miles (i.e., the first value data) acquired by the user corresponding to the member identification data which has been read from the member card. It is possible, for example, as part of a customer-building campaign, to calculate the converted miles (i.e., the third value data) by doubling the value of the miles issued by the participating stores (i.e., the second value data) during a given month, and use these converted miles in the updating (which is done by addition, for example) of the miles acquired by the user (i.e., the first value data).

Further, according to the present invention a miles management method for managing airline company reward miles acquired by each of users, comprises: recording miles issued by a participating store for each transaction with the participating store onto a card-type first information storage medium carried by a user; reading the miles issued by the participating store from the card-type first information storage medium and user identification data from a card-type second information storage medium carried by the user; and updating the reward miles acquired by the user corresponding to the user identification data read from the card-type second information storage medium, based on the miles issued by the participating store read from the card-type first information storage medium.

### BRIEF DESCRIPTION OF THE DRAWINGS

In the accompanying drawings:

FIG. 1 is a diagram depicting a construction of a system of a miles management system for explaining one embodiment of the present invention;

FIG. 2 is a diagram depicting an outward appearance of a convenience card used in the embodiment of the present invention, and an example of a print out on this convenience card;

FIG. 3 is a diagram depicting an example of a print out on the convenience card used in the embodiment of the present invention; and

FIG. 4 is a perspective diagram of a miles registration terminal used in the embodiment of the present invention.

### DETAILED DESCRIPTION OF THE PREFERRED EMBODIMENTS

Hereinafter, explanation will be made of a miles management system which uses a value data management method and a value data management system according to an embodiment of the present invention, making use of the drawings.

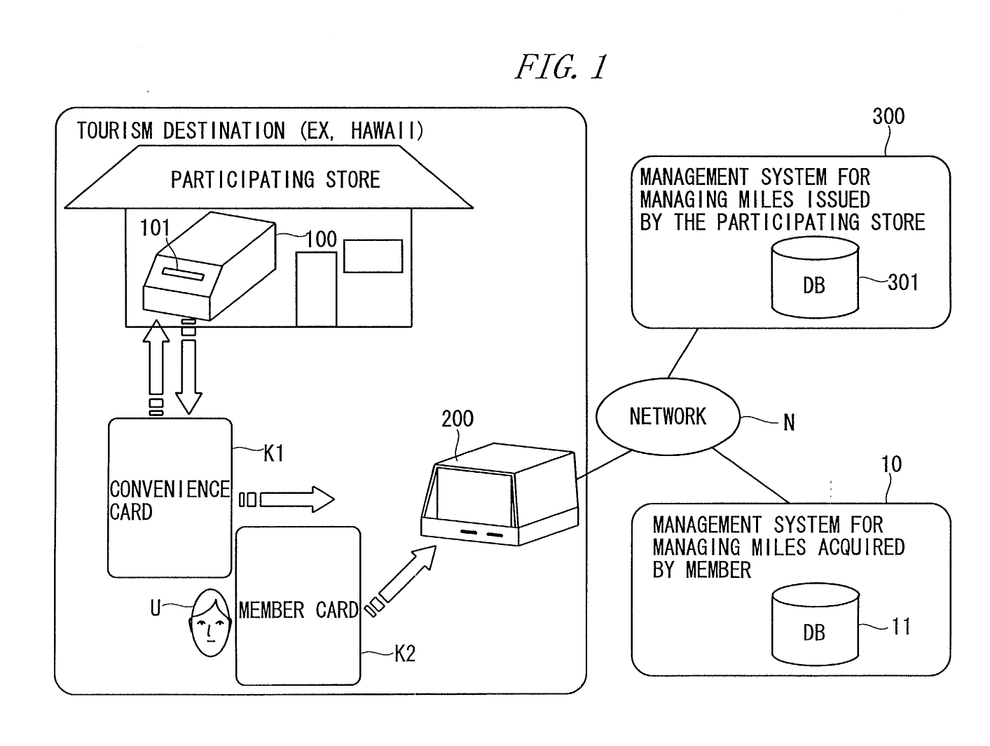

FIG. 1 is a schematic diagram depicting a construction of a system of a miles management system having an acquired member miles management system 10; a card read-writer 100; a miles registration terminal 200; and a management system 300 for managing miles issued by participating stores.

The acquired member miles management system 10 is provided in a designated location, such as in Japan. It is for managing the acquired member miles (a first value data) which have a value exchangeable for specific merchandise (including free plane tickets, for example) and which have been acquired by each of users who have joined a miles service offered by an airline company and who have registered as members. The acquired member miles management system 10 is comprised of a computer system.

The acquired member miles management system 10 has a member database 11, and in this member database 11, user identification data of a member and the acquired member miles acquired by that given member are linked to each other and recorded (or stored). A member card (a second information recording medium) is given to the member on which the user identification data of that member is recorded.

In the present embodiment a user U is participating in the miles service offered by the airlines company and is registered as a member thereof. The member identification data and the acquired member miles of this user U are managed by means of the acquired member miles management system 10. The user U has his member card K2 on which his user identification data is recorded.

The card read-writer 100 is provided in a participating store in a certain area (such as Hawaii, for example), and is a device for recording onto the convenience card K1 (i.e., the first information recording medium) miles issued by the participating store and having a value which is reflective of the monetary amount of a transaction (i.e., a second value data). For the convenience card K1 it is possible to use various types of information storage media such as a PET card having a magnetic data recording area, some other magnetic card, or an IC card. In the case when the convenience card K1 is a magnetic card, the miles issued by the participating store are recorded as magnetic data.

On the card read-writer 100 there is provided a convenience card insert hole 101. Upon the purchase of merchandise (including services) the user U hands over the convenience card K1 and a staff person of the participating store inserts this into the convenience card insert hole 101. A transaction amount input device such as a keyboard or a POS (not shown) is connected to the card read-writer 100. When the staff person of the participating store inputs the monetary amount of the transaction into the card read-writer 100 through the transaction amount input device, miles are issued by the participating store which have a value reflecting the inputted transaction amount, and these miles are recorded on the inserted convenience card K1. Further, the issue dates of these miles issued by the participating store are recorded onto the inserted convenience card K1.

The card read-writer 100 is provided with a recording device (not shown) storing a table in which a correspondence is established between the transaction amount and the miles issued by the participating store, and this table is used for the participating store to perform the issuing of the miles reflective of the inputted transaction amount.

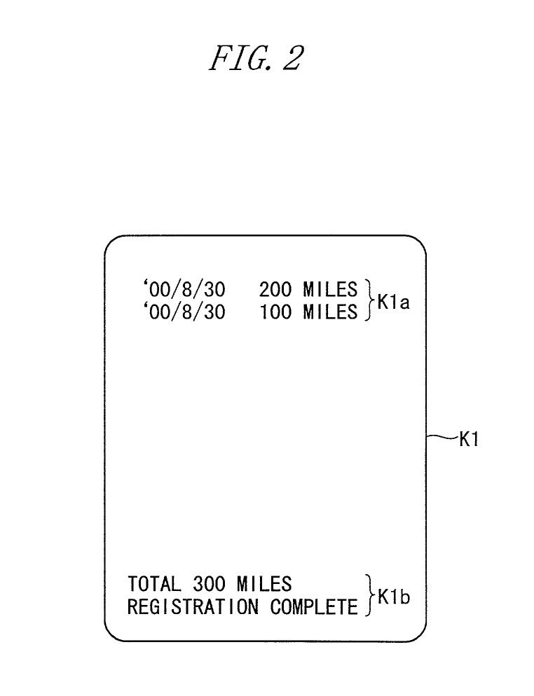

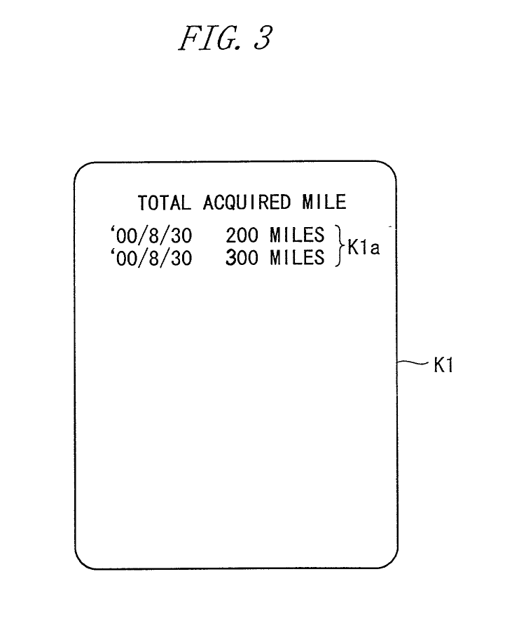

The card read-writer 100 has a printing device (not shown) which is used as a printing means for printing the miles issued by the participating store onto the convenience card K1. The miles issue date and the miles issued by the participating store K1a are printed onto the convenience card K1 as shown in FIG. 2, for example. In the same diagram there is shown an example in which the issued miles themselves are printed each time the miles are issued by the participating store. Note, however, that a configuration is also possible in which miles which are a sum of miles issued to date are printed each time miles are issued. Thus, FIG. 3 depicts an example of such a configuration printed onto the convenience card K1, corresponding to the same two transactions shown in FIG. 2. When the printing of the miles issued by the participating store is completed, the convenience card K1 is ejected from the convenience card insert hole 101 and returned to the user U by the staff person of the participating store.

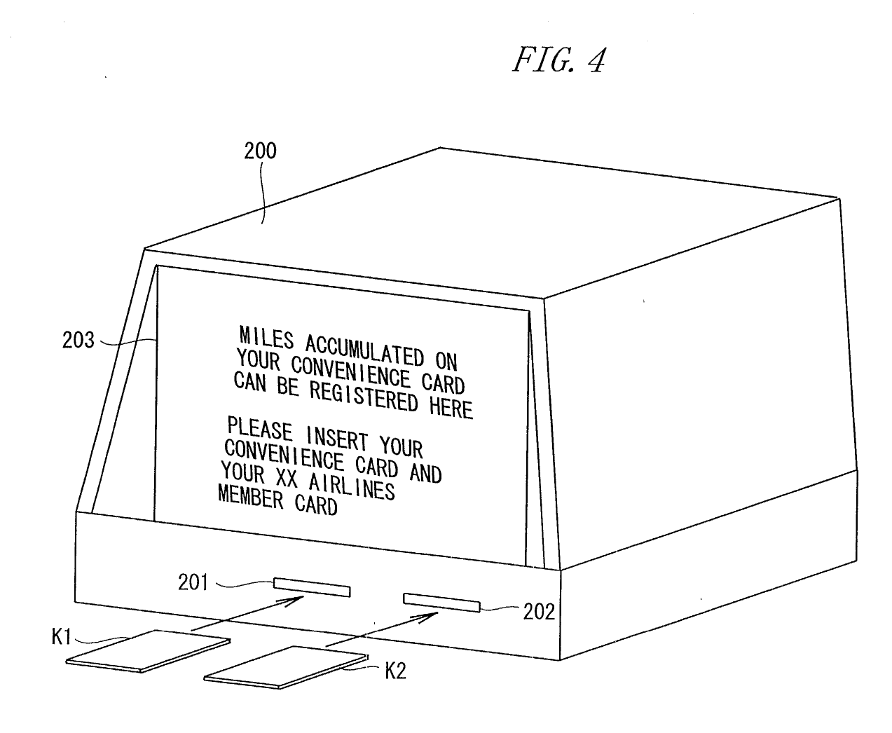

Next explanation will be made of the miles registration terminal 200 used as an information acquisition means, making reference to FIG. 4. FIG. 4 is a perspective diagram of the miles registration terminal 200.

The miles registration terminal 200 is provided in such a place as the front desk of an airport (for example, Honolulu Airport), and is for reading the miles which have been issued by the participating store and recorded onto the convenience card K1, and for reading the customer identification data recorded onto the member card K2. Note that the miles registration terminal 200 is not limited to the front of an airport, but can also be provided in such a place as an office, for example, in which the management system 300 for managing miles issued by participating stores is provided.

The miles registration terminal 200 for registering miles issued by participating stores is provided with a convenience card insert hole 201 and a member card insert hole 202. A display 203 provided to the miles registration terminal 200 for registering miles issued by participating stores displays a screen giving instructions to insert each of the cards.

When a user wishes to register miles issued by a participating store and recorded (accumulated) on the convenience card K1, the user inserts the convenience card K1 and the member card K2 into the insert holes 201, 202. The miles registration terminal 200 has a card reader (i.e., information acquisition means) built in, and with this card reader it is able to read the miles issued by the participating store and recorded onto the inserted convenience card K1 from the convenience card K1, and read the user identification information recorded onto the member card K2 from the member card K2. Note, however, that it is also possible to insert the cards into one insert hole one at a time, and read them one at a time.

The miles registration terminal 200 has a built-in printing device (not shown) for acting as a printing means for printing onto the convenience card K1 an indication that the reading of the miles issued by the participating store and recorded onto the convenience card K1 has finished. The sum of the miles issued by the participating store and recorded (accumulated) on the convenience card K1 and the words “Registration Complete” K1b as shown in FIG. 2, for example, are printed onto the inserted convenience card K1.

When the printing onto the convenience card K1 has finished, its magnetic data is deleted and it is ejected from the insert hole 201 and returned to the user U. The member card K2 is also ejected from the insert hole 202 and returned to the user U.

A communications control device (not shown) for connecting to a network such as the internet is connected to the miles registration terminal 200. For the communications control device it is possible to use devices such as a modem, a terminal adapter, a digital service unit, a router or other such devices which are appropriate for the network type. The miles issued by the participating store and the member identification data read by the card reader which is built into the miles registration terminal 200 are communicated to the management system 300 for managing miles issued by participating stores via the communications control device.

The management system 300 for managing miles issued by participating stores registers in its own database 301 the user U's user identification data and the miles issued for the user U by the participating store which have been communicated from the miles registration terminal 200, and also notifies an acquired member miles management system 10 of the user U's member identification data and the user U's miles issued by the participating store.

The acquired member miles management system 10 receives the user U's user identification data and the same user U's miles issued by the participating store, which have both been communicated from the management system 300. Then, the acquired member miles management system 10 updates the acquired member miles acquired by the user U corresponding to the user identification data received from the management system 300, based on the user U's miles issued by the participating store received from the management system 300 (the user U's miles issued by the participating store is read by the miles registration terminal 200). This can be done by adding the miles issued by the participating store to the acquired member miles, for example. Note that the object being updated is the acquired member miles which are recorded in the member database 11.

Next, explanation will be made of another embodiment.

In the embodiment described above, the acquired member miles recorded in the member database 11 were updated based on the miles issued by the participating store as read by the miles registration terminal 200. In the present embodiment, converted miles are calculated as a third value data based on the miles issued by the participating store as read by the miles registration terminal 200, and the acquired member miles recorded in the member database 11 are updated based on these calculated converted miles.

These converted miles are calculated by the management system 300 for managing miles issued by participating stores. The management system 300 for managing miles issued by participating stores records into its own database the user U's member identification data and user U's miles issued by the participating store which have both been communicated from the miles registration terminal 200, and also calculates the user U's converted miles by doing such calculations as adding a certain number of miles (e.g., 200 miles) to, or multiplying by a certain value (e.g., a value of 2) the miles which have been issued to the user U from the participating store for transactions with the participating store during a predetermined time period. The converted miles which have been calculated in this way are communicated to the acquired member miles management system 10 together with the user U's member identification data. Using the issue date on the miles issued by the participating store and recorded on the convenience card K1, a determination is made as to whether or not the miles issued by the participating store and recorded on the convenience card K1 were issued during the predetermined time period.

The acquired member miles management system 10 obtains the user U's member identification data and the converted miles, which have been communicated from the management system 300 for managing miles issued by participating stores. Then, this acquired member miles management system 10 updates the acquired member miles associated with the member identification data communicated from the management system 300 so that the acquired member miles are updated based on the converted miles thus communicated. This updating can be performed by adding the converted miles to the acquired member miles, for example. Note that the object which is updated is the acquired member miles recorded in the member database member database 11, which is the same as in the embodiment described above.

Further, the present invention can be practiced in a variety of other ways without departing from the spirit or essential characteristics thereof. Therefore, no aspect of the embodiments described above is anything more than an example, and the above is not to be interpreted as limiting descriptions.

As is explained above, the value data management method, the value data management system, and the miles management method according to the present invention enable methods and systems for providing a new service which makes use of a miles service.

What is claimed is:

1. A value data management method for managing a first value data acquired by each of users and having value exchangeable for specific merchandise, comprising:
reading second value data from a first information storage medium and user identification data from a second information storage medium; and
updating the first value data acquired by the user corresponding to the user identification data read from the second information storage medium, based on the second value data read from the first information storage medium.

2. The value data management method according to claim 1, wherein the second value data have a value reflective of the monetary amount of a transaction with a participating store.

3. The value data management method according to claim 2, wherein the second value data is recorded in the first information storage medium for each occurrence of the transaction.

4. The value data management method according to claim 1, wherein each of the first and second information storage medium is a card-type information storage medium.

5. The value data management method according to claim 1, further comprising:
calculating third value data based on the second value data read from the first information storage medium; and
updating the first value data acquired by the user corresponding to the user identification data read from the second information storage medium, based on the calculated third value data.

6. A value data management method for managing a first value data acquired by each of users and having value exchangeable for specific merchandise, comprising:
recording a second value data having a value reflective of the monetary amount of a transaction with a participating store in a specific area in a first information storage medium for each occurrence of the transaction;
reading the second value data from the first information storage medium and user identification data from a second information storage medium; and
updating the first value data acquired by the user corresponding to the user identification data read from the second information storage medium.

7. A value data management system for managing a first value data acquired by each of users and having value exchangeable for specific merchandise, the value data management system comprising:
an information acquisition means reading second value data from a first information storage medium and user identification data from a second information storage medium; and
an updating means updating the first value data acquired by the user corresponding to the user identification data read by the information acquisition means, based on the second value data read by the information acquisition means.

8. A value data management system according to claim 7, wherein each of the first and second information storage medium is a card-type information storage medium; and
the information acquisition means is a card reader.

9. A value data management system according to claim 8, wherein the card-type information storage medium is a magnetic card.

10. A value data management system according to claim 8, the system further comprising:
a printing means printing onto the card-type first information storage medium an indication that the reading of second value data from the card-type first information storage medium is complete.

11. A value data management system according to claim 8, the system further comprising:
a printing means printing the second value data onto the card-type first information storage medium.

12. A value data management system for managing a first value data acquired by each of users and having value exchangeable for specific merchandise, the value data management system comprising:
an information acquisition means reading second value data from a first information storage medium and user identification data from a second information storage medium;
a calculation means calculating third value data based on the second value data read by the information acquisition means; and
an updating means updating the first value data acquired by the user corresponding to the user identification data read by the information acquisition means, based on the third data calculated by the calculation means.

13. A miles management method for managing airline company reward miles acquired by each of users, comprising:
recording miles issued by a participating store for each transaction with the participating store onto a card-type first information storage medium carried by a user;
reading the miles issued by the participating store from the card-type first information storage medium and user identification data from a card-type second information storage medium carried by the user; and
updating the reward miles acquired by the user corresponding to the user identification data read from the card-type second information storage medium, based on the miles issued by the participating store read from the card-type first information storage medium.
